(19) United States
(12) Patent Application Publication
(10) Pub. No.: US 2008/0249832 A1
(43) Pub. Date: Oct. 9, 2008

(54) ESTIMATING EXPECTED PERFORMANCE OF ADVERTISEMENTS

(75) Inventors: Matthew R. Richardson, Seattle, WA (US); Robert J. Ragno, Kirkland, WA (US); Ewa Dominowska, Kirkland, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/696,467

(22) Filed: Apr. 4, 2007

(51) Int. Cl. G06F 17/00

(52) U.S. Cl. 705/10

(57) ABSTRACT

Systems, methods, and computer-readable media for estimating expected advertisement performance of advertisements are provided. An advertisement performance prediction model is developed using features extracted from a sample set. Once developed, advertisements that are not a part of the sample set are identified and features are extracted there from. The features are then input into the advertisement performance prediction model and expected performance of the corresponding advertisement is estimated. In embodiments, the estimated expected advertisement performance may be used to appropriately rank the advertisement relative to a plurality of other advertisements such that the advertisement will be displayed according to the advertisement ranking.

### BACKGROUND

Online advertising has become a significant aspect of the Web browsing experience. Today, many search engines receive revenue through advertisements positioned adjacent to a user's query results. For example, many search engine providers receive payment from advertisers based upon pay-per-performance models, e.g., cost-per-click or cost-per-action models. The relative placement of an advertisement with respect to a user's query results greatly affects the probability that a user will view the advertisement and/or perform a desired action, such as clicking on the advertisement, purchasing the advertised product, signing up for a newsletter, or the like. For instance, in a vertically displayed listing of search results having the most relevant result(s) positioned at or near the top of the listing, the probability of a user viewing an advertisement adjacent a lower positioned query result (and/or performing an action with respect thereto) is significantly lower than the corresponding probability of a higher positioned query result. Accordingly, it is generally beneficial for users, advertisers, and search engine providers if the best performing advertisements are placed near the top of the query results listing.

As such, determining the order in which various advertisements appear with respect to a displayed query results listing has become a task of great interest to search engine providers and advertisers alike, both of whom would like to maximize their revenue. Further, a search engine user is generally more satisfied when advertisements desirable to the user have a prominent placement. Accurately estimating expected advertisement performance, e.g., the probability that the user will click on the advertisement or perform a desired action, can aid in determining appropriate relative positioning of advertisements. Accordingly, accurately estimating expected advertisement performance can aid in maximizing the search engine provider's revenue, the advertiser's return on investment, and the user's satisfaction.

When estimating expected advertisement performance, a number of historical advertisement performance measures are typically utilized. For instance, in a cost-per-click model, click-through rates (CTRs) may be utilized to estimate the expected future performance of advertisements. Thus, if an advertisement is displayed 100 times and is selected five times by a user, the historical CTR of the advertisement is 0.05. Accordingly, the estimated future advertisement performance is also 0.05.

Utilizing historical advertisement performance measures, however, has limitations as historical performance is not always an accurate predictor of future performance. For instance, the performance of an advertisement may fluctuate drastically in a short amount of time. That is, suppose an advertisement having a historical CTR of 0.05 is not be clicked by any users the next one hundred times it is displayed. Depending upon the number of impressions for which data is available, this dry spell may significantly lower the actual CTR. To mitigate any drastic fluctuations, some search engine providers incorporate, via statistical confidences, the amount of historical data and/or the expected volatility of an advertisement. However, incorporating statistical confidences does not necessarily render accurate estimations of expected advertisement performance.

Furthermore, in some cases, sufficient historical advertisement performance measures may not exist. For example, advertisements void of any history with a search engine do not have historical advertisement performance measures associated therewith. Additionally, advertisements that have had a limited number of impressions may have insufficient historical advertisement performance measures to generate accurate estimates. In such cases, a pay-per-performance system may assign the advertisement a somewhat arbitrary performance measure, e.g., the average or median click-through rate of all known advertisements. As drastic fluctuations are likely across the spectrum of all advertisements associated with a search engine, assigning advertisement performance measures in this manner can result in radically inaccurate estimated performance measures.

### BRIEF SUMMARY

Embodiments of the present invention relate to systems, methods, and computer-readable media for estimating expected performance of advertisements. An advertisement performance prediction model is developed using advertisement features extracted from a sample set of advertisements. Once the prediction model is developed, advertisement features may be extracted from advertisements not included in the sample set and the model may be used to estimate the advertisement's expected performance. The estimated expected advertisement performance may then be used to appropriately rank the advertisement among a plurality of advertisements. In embodiments, the advertisement for which performance is estimated may be displayed in accordance with its ranking, thereby improving search engine provider and advertiser revenues, as well as user satisfaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is a block diagram of an exemplary computing system architecture suitable for use in implementing embodiments of the present invention;

FIG. 3 is a flow diagram illustrating a method for developing an advertisement performance prediction model, in accordance with an embodiment of the present invention; and

FIG. 4 is a flow diagram illustrating a method for implementing an advertisement performance prediction model, in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide systems, methods, and computer-readable media for developing an advertisement performance prediction model and utilizing the prediction model to estimate expected performance of advertisements. The advertisement performance prediction model is developed using advertisement features extracted from a sample set. In embodiments, the advertisement performance prediction model may be a logistic regression model, a decision tree, or any other prediction model known to those of ordinary skill in the art. To estimate expected advertisement performance, advertisement features are extracted from an advertisement that was not included in the sample set. The extracted advertisement feature(s) is then input into the advertisement performance prediction model and expected advertisement performance is estimated. The estimated expected advertisement performance may then be used to appropriately rank the advertisement with respect to a plurality of other advertisements. In embodiments, the advertisement may be displayed in accordance with the advertisement ranking, thereby improving search engine provider and advertiser revenues, as well as user satisfaction.

Accordingly, in one aspect, the present invention provides a computerized system for developing an advertisement performance prediction model configured to estimate expected performance of advertisements. The system includes an extracting component and a developing component. The extracting component is configured to extract at least one advertisement feature from a plurality of advertisements, one or more of the plurality of advertisements having at least one historical measure of performance associated therewith. The developing component is configured to develop the advertisement performance prediction model utilizing the extracted advertisement feature(s) and the historical performance measure(s) for each of the plurality of advertisements.

In another aspect, the present invention provides a method for estimating expected performance of advertisements. The method includes receiving an advertisement; extracting at least one feature, e.g., an advertisement feature, from the received advertisement; inputting the extracted feature(s) into an advertisement performance prediction model, the advertisement performance prediction model being based upon extracted features, recognized information items and/or historical performance of a plurality of advertisements; and utilizing the advertisement performance prediction model to estimate expected performance of the received advertisement. In embodiments, at least one user feature (e.g., gender, age, location, interests, previous click behavior, and the like) and/or the day or time of the request may be extracted from the received advertisement instead of, or in addition to, advertisement features.

In a further aspect, the present invention provides one or more computer-readable media having computer-executable instructions embodied thereon that, when executed, perform a method for estimating expected performance of advertisements. The method includes identifying at least one advertisement having one or more recognized information items and/or performance measures associated therewith, extracting one or more advertisement features from the advertisement(s), developing an advertisement performance prediction model based upon the extracted advertisement feature(s) and at least one of the recognized information items and/or performance measures; extracting at least one advertisement feature from a first advertisement that is different than the at least one advertisement; and estimating the expected advertisement performance measure of the first advertisement utilizing the advertisement performance prediction model.

Having briefly described an overview of embodiments of the present invention, an exemplary operating environment suitable for implementing embodiments hereof is described below.

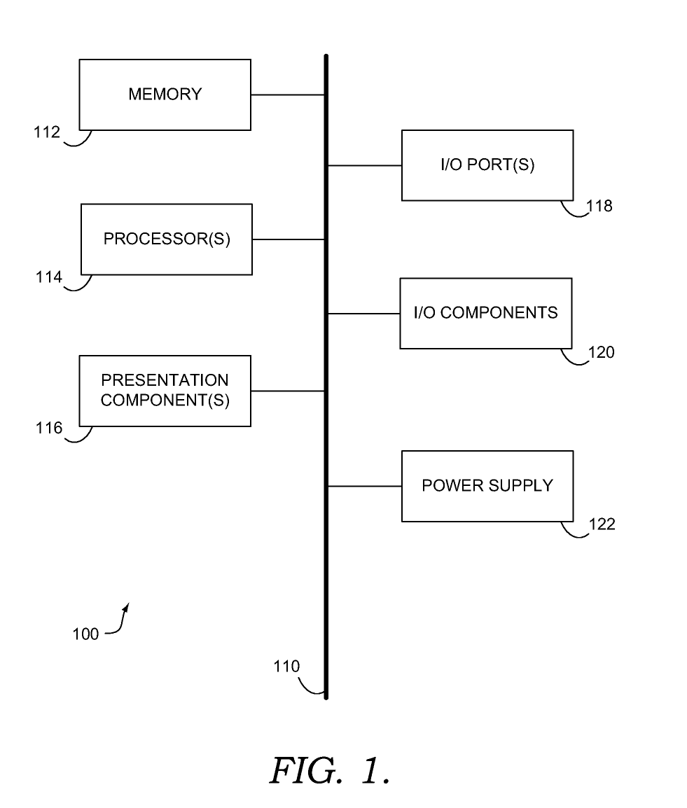

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/modules illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks, or implement particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, etc. I/O ports 118 allow computing device 100 to be logically coupled to other devices including I/O modules 120, some of which may be built in. Illustrative modules include a microphone, joystick, game pad, satellite dish, scanner, printer, wireless device, etc.

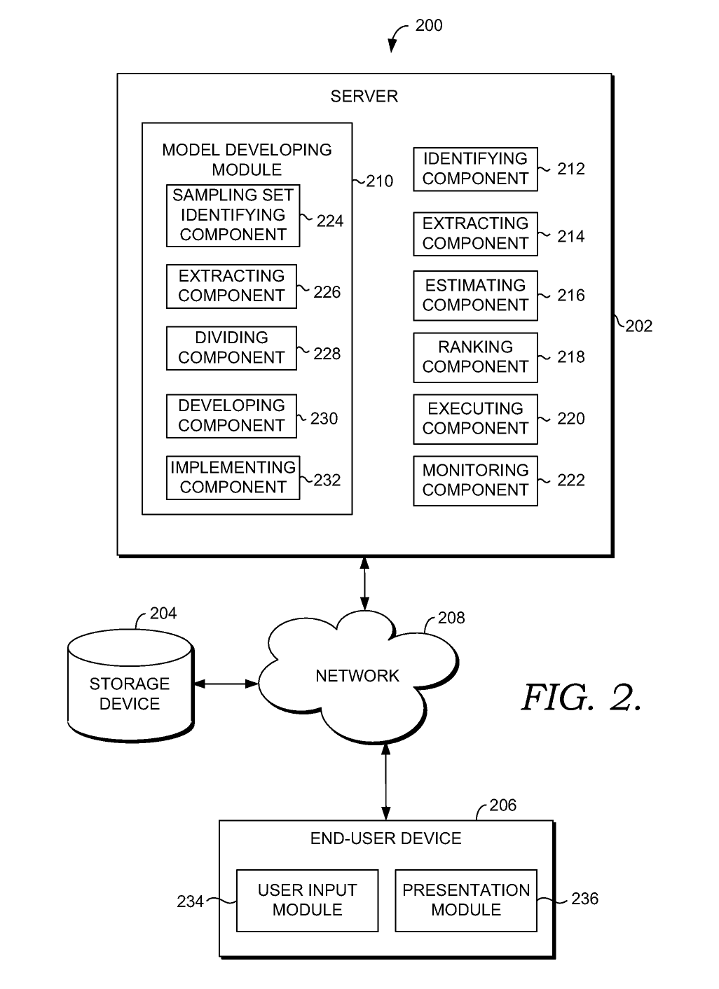

As previously set forth, embodiments of the present invention relate to computing systems for developing advertisement performance prediction models and utilizing such models to estimate expected performance of advertisements. With reference to FIG. 2, a block diagram is illustrated that shows an exemplary computing system architecture 200 configured for developing such a model and utilizing the model to estimate expected advertisement performance, in accordance with an embodiment of the present invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single module/component or combination of modules/components illustrated therein.

Computing system architecture 200 includes a server 202, a storage device 204, an end-user device 206, all in communication with one another via a network 208. The network 208 may include, without limitation, one or more local area networks (LANs) and/or wide area networks (WANs). Such networking environments are commonplace in offices, enterprise-wide computer networks, intranets and the Internet. Accordingly, the network 208 is not further described herein.

The storage device 204 is configured to store information associated with advertisement performance. In various embodiments, such information may include, without limitation, advertisement features, recognized advertisement information items, advertisement performance measures, and the like. In embodiments, the storage device 204 is configured to be searchable for one or more of the items stored in association therewith. It will be understood and appreciated by those of ordinary skill in the art that the information stored in the storage device 204 may be configurable and may include any information relevant to advertisement performance. The content and volume of such information are not intended to limit the scope of embodiments of the present invention in any way. Further, though illustrated as a single, independent component, the storage device 204 may, in fact, be a plurality of storage devices, for instance a database cluster, portions of which may reside on the server 202, the end-user device 206, another external computing device (not shown), and/or any combination thereof.

Each of the server 202 and the end-user device 206 shown in FIG. 2 may be any type of computing device, such as, for example, computing device 100 described above with reference FIG. 1. By way of example only and not limitation, each of the server 202 and the end-user device 206 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

As shown in FIG. 2, the server 202 includes a model developing module 210, an identifying module 212, an extracting module 214, an estimating module 216, a ranking module 218, an executing module 220, and a monitoring module 222. In some embodiments, one or more of the illustrated modules may be implemented as stand-alone applications. In other embodiments, one or more of the illustrated modules may be integrated directly into the operating system of the server 202 and/or the end-user device 206. It will be understood by those of ordinary skill in the art that the modules illustrated in FIG. 2 are exemplary in nature and in number and should not be construed as limiting. Any number of modules may be employed to achieve the desired functionality within the scope of embodiments hereof. Further, modules may be located on any number of servers or computers. By way of example only, model developing module 210 may reside on a separate server or computer. In such a case, the developed advertisement performance prediction model may be sent to the server networked to an end user.

The model developing module 210 is configured for developing an advertisement performance prediction model configured to estimate expected performance of advertisements. Expected advertisement performance may include, by way of example only and not limitation, the probability a user will select a displayed advertisement, i.e., click-through rate (CTR), the probability a user will perform another action with respect to a displayed advertisement (e.g., purchase a product, sign up for a newsletter, and the like), or any other measure of performance known to those of ordinary skill in the art. The model developing module 210 illustrated in FIG. 2 includes a sample set identifying component 224, an extracting component 226, a dividing component 228, a developing component 230, and an implementing component 232. In some embodiments, one or more of the illustrated components may be implemented as stand-alone applications. In other embodiments, one or more of the illustrated components may be integrated directly into the operating system of the server 202. It will be understood by those of ordinary skill in the art that the components illustrated in FIG. 2 are exemplary in nature and in number and should not be construed as limiting. Any number of components may be employed to achieve the desired functionality within the scope of embodiments hereof.

The sample set identifying component 224 is configured for identifying advertisements having at least one recognized information item and/or performance measure associated therewith. The sample set identifying component 224 is further configured for creating a sample set of advertisements that includes at least a portion of the advertisements identified. Recognized information items may include, without limitation, the URL to which a user is redirected upon selecting a displayed advertisement (i.e., the landing page), the bid terms for which the advertisement should be displayed (i.e., particular words and/or phrases for which an advertiser bids an amount it is willing to pay each time a user selects or clicks on a displayed advertisement as a result of the search engine query and thus accesses the information item(s) associated therewith), the advertisement title, the textual description of the advertisement, the URL shown to the user in association with the advertisement (i.e., the display URL), the number of times the advertisement has been selected since it was entered into the system, the number of times the advertisement has been viewed since it was entered into the system, and the like. Recognized advertisement performance measures may include, for example, observed click-through rates, advertisement performance changes, or any other advertisement performance measures known to those of ordinary skill in the art. In one embodiment, because an advertisement's performance, such as a CTR, may be different for each associated bid term, each pairing of the advertisement with a bid term may be considered a separate advertisement.

It will be understood and appreciated by those of ordinary skill in the art that embodiments of the present invention are not limited to any particular recognized information items and/or performance measures. Any and all variations, and combinations thereof, known to those of ordinary skill in the art are contemplated to be within the scope of embodiments hereof.

In identifying advertisements with recognized advertisement information item(s) and/or advertisement performance measures, the sample set identifying component 224 may be configured to identify a predetermined number (e.g., one million) or portion (e.g., 25%) of existing advertisements having observed advertisement information item(s) and/or advertisement performance measures. Alternatively, the sample set identifying component 224 may identify all existing advertisements, advertisements included in a specific advertisement category or grouping, advertisements identified by an algorithm, or advertisements displayed or created within a specific time period (e.g., advertisements displayed within the last year) or displayed a specific number of times (e.g., advertisements displayed more than 100 times).

In creating a sample set of advertisements including at least a portion of the identified advertisements, the sample set identifying component 224 may be configured to create a sample set including a predetermined number or portion of identified advertisements, e.g., a percent or fraction of the identified advertisements. Alternatively, the sample set identifying component 224 may be configured to create a sample set including all identified advertisements; identified advertisements included in a specific advertisement category or grouping; identified advertisements specified by an algorithm; or identified advertisements displayed, created, or identified within a specific time period (e.g., the last six months) or a specific number of times, (e.g., the last one million advertisements identified).

The sample set identifying component 224 may exclude advertisements from a sampling set to maximize model accuracy. In some embodiments, advertisers with accounts that are professionally managed may be excluded from a sample set. In such a case, professionally managed advertisements are excluded because those advertisements frequently exhibiting different trends from non-professionally managed advertisements. In other embodiments, to ensure significant variation, only a specific number of advertisements per advertiser, e.g., 1000 advertisements per advertiser, may be included in the sample set. In yet other embodiments, advertisements displayed less than a specific number of times, e.g., 100 views, may be excluded from the sample set to provide a reasonable level of confidence in the observed CTR for the advertisements used as examples. In such a case, advertisements that have been displayed a greater number of times may produce a sample set with less noise, as the estimated CTR values are more accurate; however, the examples may be biased away from the general behavior of new advertisements.

The advertisements identified by the sample set identifying component 224, or the advertisements included in a sample set, may be identified or gathered from a storage device such as storage device 204. As previously mentioned, the storage device 204 may be a database, an intermediary file having aggregated information, or a log file having information pertaining to clicks, actions, impressions, and the like. It will be understood by those of ordinary skill in the art that any number of storage devices may be employed to achieve the desired functionality within the scope of embodiments. In one embodiment, databases, intermediary files, and log files may all be utilized to store advertisement information item(s). Alternatively, the advertisements identified and/or the advertisements included in a sample set may be identified or gathered upon the advertisement being entered into the system or upon the advertisement being displayed in association with the search engine.

The extracting component 226 is configured to extract advertisement features for advertisements in the sample set, e.g. the sample set created by the sample set identifying component 224. An advertisement feature may be a value or datum that represents advertisement information item(s) or an advertisement performance measure, e.g., the number of words in the advertisement title, the existence of a word, or a CTR. As previously mentioned, advertisement information may include, for example, a landing page, a bid term, a title, a body, a display URL, the number of clicks, or the number of views. Advertisement performance measures may include click-through rates or other advertisement performance measures. In embodiments, to extract advertisement features, the extracting component converts advertisement information and advertisement performance measures to values or data.

In one embodiment, the extracting component 226 may retrieve advertisement information or advertisement performance measures from a database, file, or the like. Alternatively, the extracting component 226 may receive an advertisement having advertisement information and advertisement performance measures associated therewith when it enters the system, upon the advertisement being displayed, or upon a random selection of the advertisement. Upon retrieving or receiving one or more advertisements and corresponding information and performance measures, the extracting component 226 thereafter converts the advertisement information and/or advertisement performance measures to data, values, or the like. In some instances, advertisement information or advertisement performance measures of a particular advertisement may have been previously converted to a datum or value and stored. In such a case, the extracting component 226 may simply retrieve the extracted feature from a database, file, or the like.

In one embodiment, the extracted advertisement features may be stored in a file, database, or like storage device, such as storage device 204. Alternatively, the advertisement features may be used to develop an advertisement performance model and thereafter discarded.

The extracting component 226 may extract a variety of advertisement features. Advertisement features may pertain to advertisement information or advertisement performance measures independent of user behavior, advertisement information or advertisement performance dependent on user behavior, or a combination thereof. Advertisement features may be categorized into a variety of feature sets including advertisement copy features, advertisement breadth features, advertisement consistency features, advertisement page features, specific advertisement features, CTR advertisement features, performance based features, query-based features, search data features, and the like. One skilled in the art will recognize that a plurality of feature sets may exist, including combinations of the feature sets discussed hereinafter. The feature sets discussed herein are not intended to limit the scope of embodiments of the present invention.

A first feature set, advertisement copy features, includes features that capture the advertisement creativity and estimate the significance of the advertisement creativity on expected advertisement performance. Features in this set may pertain to, for example, advertisement title length in characters, advertisement text length in characters, advertisement title length in number of words, advertisement text length in number of words, whether a display URL is a valid URL, whether advertisement text contains punctuation, whether advertisement text is aesthetically pleasing, whether an advertisement contains numbers, whether an advertisement contains action words, and the like.

A second feature set, advertisement breadth features, includes features that capture the breadth of target of an advertisement, e.g., categorical entropy of keywords bid by an advertiser, number of unique terms bid upon in the advertiser's account, and the like. Advertisement breadth features incorporate the breadth of bid terms and other actions for which the advertiser would like the advertisement to be displayed, e.g., generality or specialization of the terms bid upon in association with an advertisement. Generally, generic advertisements are less likely to answer a user needs; accordingly, generic advertisements are less likely to result in direct user actions. For example, a car manufacturer may desire an advertisement to be displayed when a user queries for “car” or “fast cars.” In such a case, the advertisement breadth feature indicates the generality of the bid upon terms. In some embodiments, generality and specialization may be demonstrated by URLs rather than bid upon terms. For example, an advertiser advertising web pages may specify the web pages on which the advertisement is displayed.

As previously mentioned, in some embodiments, the breadth of target of an advertisement may be captured by measuring the entropy of the bid upon terms across categories. For example, phrases may be classified into categories by executing a search query for each phrase and running the text classification algorithm on the search result snippets. In such a case, each term is categorized into a category, e.g., autos, shopping, and technology. The category entropy is then calculated in bits, resulting in an advertisement breadth feature.

A third feature set, advertisement consistency features, incorporate the consistency of bid terms, advertisement text, advertisement title, landing page, and combinations thereof. In one aspect, the feature may pertain to whether the bid upon terms are represented in the advertisement text, advertisement title, or landing page. For example, an advertiser may request an advertisement to be displayed in “art” categories. In such a case, the advertisement consistency feature may have a low value where the advertisement pertains to selling cars or where the landing page pertains to hotels.

A fourth feature set, advertisement page features, estimates the overall quality of an advertiser by analyzing the quality and complexity of the landing page, i.e., the page the user would go to after selecting the advertisement. Although the landing page is only viewed upon a user selecting the advertisement, many users may click on advertisements produced by familiar advertisers. Accordingly, the quality of the landing page may be indicative of the probability a user will click on the advertisement. The features in this set include, for example, AdSense® advertisements on the landing page, ratio of text to html on landing page, number of images on the landing page, landing page conforming to W3C standard, amount of image pixels on the landing page, whether the landing page uses javascript, whether the landing page contains flash, server speed, number of links, internal to external link ratio, and the like.

A fifth feature set, specific advertisement features, captures the occurrence of specific words or phrases that may captivate the user or turn the user away. The features in this set may pertain to, for example, the occurrence of specific words in the advertisement title, the occurrence of specific words in the advertisement text, the occurrence of specific words in association with the advertisement landing page, and the like. The specific words and phrases may be determined based on the performance history of advertisements having those words. In one embodiment, the specific words and phrases are determined based on a predetermined number of the most common words in the advertisement title and advertisement body of the training set, e.g., 10,000 most common words. In one instance, the specific advertisement feature may have a value of one if the word exists in the advertisement or a value of zero if the word does not exist in the advertisement. In another instance, the specific advertisement feature may have a value comprising the number of times the word occurred in the advertisement, or the log thereof.

A sixth feature set, click-through rate (CTR) advertisement features, considers the observed CTR of existing advertisements having common and related bid terms. The features in this set may pertain to, for example, how well did advertisements for the same bid terms as this advertisement perform, how well did advertisements perform that contain a superset of bid terms of this advertisement, how well did advertisements perform that contain all but one of bid term of this advertisement, and the like. The CTR advertisement feature may vary depending on the commonality of bid terms. For example, an advertisement sharing only one bid term out of five with another advertisement may have a small feature value. On the other hand, advertisements that share two bid terms out of a total of two bid terms may have a large feature value.

In one embodiment, a CTR advertisement feature is based upon the CTR of other advertisements that have the same bid term. In such a case, the CTR advertisement feature may be determined utilizing the following algorithm:

$${f}_{o} ( ad ) = \frac{a \overline{CTR} + N ( {ad}_{term} ) CTR ( {ad}_{term} )}{a + N ( {ad}_{term} )}$$

In the above algorithm, N(term) is the number of advertisements with the given bid term, CTR(term) is the average CTR for those advertisements, and C̅T̅R̅ is the mean CTR for all advertisements in the training set. σ sets the strength of the prior, in terms of number of views. In one instance, σ may be set to one. In another instance, CTRs of other advertisements having the same advertiser are not included. In yet another instance, to account for advertisements whose bid terms have not been displayed, the probabilities may be smoothed to the mean advertisement CTR as measured from a portion, such as the training set, of the sample set.

In some embodiments, a CTR advertisement feature may be based upon the CTRs of other advertisements having common bid terms. For example, comparing an advertisement having a bid term of “red shoes” to another advertisement having a bid term of “buy red shoes” may increase the accuracy of estimating the expected CTR of the advertisement having a bid on “red shoes.” In one embodiment, CTR advertisement features are determined based on clustering terms.

In another embodiment, CTR advertisement features may be determined based on subsets and supersets of the bid term. In such an embodiment, a CTR advertisement feature, i.e., the average CTR of the set of related advertisements, may be determined utilizing the following algorithm:

$${CTR}_{mn} ( term ) = \frac{1}{{R}_{mn} ( term ) \vert} {\sum }_{x ∈ {R}_{mn} ( term )} {CTR}_{X}$$

In the above algorithm, Rₘₙ(t) is the set of advertisements whose terms are the same as t when one removes m words from t and n words from the advertisement term and have at least one term in common. Rₘₙ(t) may be determined utilizing the following algorithm:

$${R}_{mn} ( t ) = \{ ad \text{:} \vert \begin{matrix} {ad}_{term} ⋂ t \vert > 0 and \\ t - {ad}_{term} \vert = m and \\ {ad}_{term} - t \vert = n\end{matrix} \}$$

By way of example, if t is “red shoes,” then an advertisement for “buy red shoes” will appear in R₀₁, and advertisement for “shoes” will be in R₁₀, and an advertisement for “blue shoes” will be in R₁₁. R₀₀ is the set of exact-match advertisements, Rₘ₀ is any advertisement whose terms are missing m words (vs t), and R₀ₙ is any advertisement that has extra n terms. Additionally, m or n may take the value *, which means “any value.” Hence, R_{0*} is any advertisement whose terms are a superset of the advertisement in question.

In some embodiments, the CTRₘₙ(term) may be smoothed by utilizing the average C̅T̅R̅ₘₙ. In some embodiments, a further feature may be the number of related terms.

Other feature sets may include, for example, performance-based features, query-based features, and/or search data features. Performance-based features consider advertisement performance by the same or similar advertisers. Query-dependent features consider how relevant a user's query is to an advertisement, how relevant a user's query is to a bid upon term, the number of words in a query, and the like. Search data features may consider the approximate frequency of the term occurring on the Web and the approximate frequency with which search engine users query for the term. To approximate frequency of the term occurring on the Web, in one embodiment, a search engine, such as MSN® search engine, may be queried to determine the number of pages the search engine claims contain the advertisement's term. To approximate the frequency with which search engine users query for the terms, in one embodiment, a specified period of logs from a search engine, such as MSN® search engine, may be utilized.

In addition to extracting advertisement features, the extracting component 226 may also extract a variety of user features and request features. User features may include, for example, gender, age, location, interests, previous searches, and previous advertisement click behavior. Request features may include, for example, the day of the request or the time of the request. Any and all such variations, and combinations thereof, are contemplated to be within the scope of embodiments of the present invention.

Returning now to FIG. 2, the dividing component 228 is configured to divide the sample set into subsets. The sample set may be divided into a training set and a testing set. For example, if the sample set includes one million advertisements, the sample set may be divided into 800,000 advertisements in the training set and 200,000 advertisements in the testing set. The advertisements in the training set are utilized to develop the advertisement performance prediction model. The advertisements in the testing set are utilized to test the advertisement performance prediction model. In one embodiment, to prevent train-test contamination, the training set of advertisements excludes advertisement information pertaining to the testing advertisements. For example, to estimate expected CTRs as though no knowledge about the advertisement and other advertisements entered by the same advertiser exist, all advertisements by the same advertiser may be divided into the same set, i.e., all such advertisements are included in the training set or all such advertisements are included in the testing set.

The sample set may also be divided into three subsets including a training set, a testing set, and a validation set. For example, if the sample set includes one million advertisements, the sample set may be divided into 700,000 advertisements in the training set, 200,000 advertisements in the testing set, and 100,000 advertisements in the validation set. The advertisements in the validation set are utilized to validate progression of the model during the training stage of the model's development. For example, if during the model's training stage development, a modification has occurred, the 100,000 advertisements in the validation set may be utilized to determine whether the modification is appropriate.

In embodiments where the sample set is divided into subsets, the number of advertisements in each subset may be determined randomly by the computer or search engine provider. Alternatively, the number of advertisements in each subset may be a predetermined number or determined by an algorithm. One skilled in the art will recognize that the sample set may be divided into any number of subsets, and the subsets may have any number of advertisements. In some embodiments, the sample set may not be divided into subsets.

The developing component 230 is configured to develop the advertisement performance prediction model based on the learned data. One skilled in the art will recognize that the advertisement performance prediction model may be in the form of a logistic regression model, a decision tree, a linear regression model, a regression tree, a neural network, a support vector machine (SVM), a boosted tree, or another model form. The prediction model may be developed via machine learning, an algorithm, or a combination thereof.

In one embodiment, an advertisement performance measure, such as CTR, may be determined utilizing the following logistic regression algorithm:

$$CTR = \frac{1}{1 + {e}^{- Z}} Z = {\sum }_{i} {w}_{i} {f}_{i} ( ad )$$

In the above logistic regression algorithm, fᵢ(ad) is the value of the i^{th} feature for the advertisement, and wᵢ is the learned weight for that feature. In one embodiment, the logistic regression model may be trained using the limited-memory Broyden-Fletcher-Goldfarb-Shanno (L-BFGS) method and using a cross-entropy loss function, with zero-mean Gaussian weight priors with a standard-deviation of σ. In some instances, a bias feature that is set to one may be added. For each fᵢ, derived features of log (fᵢ+1) and fᵢ² may be added. In addition, the features may also be normalized to have zero mean and unit standard deviation. Further, to remove significant outliers, feature values more than a specific number of standard deviations, such as five standard deviations, from the mean may be truncated to the specific number, e.g., five.

In addition to initially developing an advertisement performance prediction model, developing component 230 may further develop the model by utilizing the testing subset to measure the performance of the advertisement performance prediction model. In an embodiment using a logistic regression model, the measure of performance may be the average KL-divergence between the model's predicted CTR and the true CTR on the test set. The KL-divergence is the log-likelihood of the model minus the entropy of the test set. In an embodiment using such a performance measure, a perfect model would score zero.

Implementing component 232 is configured to implement the developed advertisement performance prediction model so that expected advertisement performance may be estimated. In one embodiment, implementing component 232 may be used only once to initially implement a new prediction model or update a preexisting prediction model. In another embodiment, implementing component 232 may be used multiple instances to periodically update the prediction model. In such an embodiment, the model generating module 210 may be executed randomly, at predetermined times, such as once a week, upon request of a search engine provider, or upon a specified condition, such as a low or decreased estimating confidence or prediction model measure of performance, e.g., KL-divergence.

Upon determining the advertisement performance prediction model at module 210, the identifying module 212 is configured to identify advertisements for which an expected advertisement performance may be estimated. Advertisements may be identified via a randomized method, a predetermined algorithm, or the like. In one embodiment, only advertisements new to the system or advertisements displayed a limited number of times may be identified. In another embodiment, all advertisements in the system may be identified. Alternatively, advertisements with low or decreasing estimating confidences may be identified as advertisements for which an expected advertisement performance may be estimated.

The extracting component 214 is configured to extract features from advertisements identified by identifying module 212. One skilled in the art will recognize that extracting component 214 functions in the same manner as extracting component 226 in the model generating module 210. Furthermore, extracting component 226 and extracting component 214 may be combined into one extracting component or a plurality of extracting components. As previously mentioned, advertisement features may pertain to advertisement information independent of user behavior, advertisement information dependent on user behavior, or a combination thereof. As with extracting component 226, advertisement features may be categorized into a variety of feature sets including advertisement copy features, advertisement breadth features, advertisement consistency features, advertisement page features, specific advertisement features, CTR advertisement features, performance based features, query-based features, search data features, and the like.

The extracting component 214 is configured to extract advertisement features for advertisements identified by identifying module 212. An advertisement feature may be a value or datum that represents advertisement information or an advertisement performance measure, e.g., the number of words in the advertisement title, the existence of a word, or a CTR. As previously mentioned, advertisement information may include, for example, a landing page, a bid term, a title, a body, a display URL, the number of clicks, or the number of views. Advertisement performance measures may include click-through rates or other advertisement performance measures. In embodiments, to extract advertisement features, the extracting component 214 converts advertisement information and advertisement performance measures to values or data.

In one embodiment, the extracting component 214 may retrieve advertisement information or advertisement performance measures from a database, file, or the like. Alternatively, the extracting component 226 may receive an advertisement having information and performance measures upon the advertisement entering the system, upon the advertisement being displayed, or upon a random selection of the advertisement. Upon retrieving or receiving one or more advertisements and corresponding information and performance measures, the extracting component 214 thereafter converts the advertisement information and performance measures to data, values, or the like.

In one embodiment, the extracted advertisement features may be stored in a file, database, or like storage device, such as storage device 204. Alternatively, the advertisement features may be used to develop an advertisement performance model and thereafter discarded.

The estimating module 216 is configured to estimate the expected performance of an advertisement. The advertisement for which an expected performance is estimated may be a new advertisement or an existing advertisement. Accordingly, estimating module 216 may be configured to estimate the initial expected performance for a new advertisement or estimate an updated expected performance for an existing advertisement. To estimate an expected advertisement performance of either a new advertisement or existing advertisement, estimating module 216 utilizes an advertisement performance prediction model, e.g., a model determined by model generating module 210. In one embodiment, estimating module 216 estimates the expected click-through rate for an advertisement. One skilled in the art will recognize that estimating module 216 may estimate any advertisement performance measure. The estimated expected advertisement performance may be stored in a storage device, such as storage device 204.

The ranking module 218 is configured to determine advertisement rankings and adjust advertisement rankings, if necessary. The advertisement ranking for each advertisement is determined based on the respective estimated expected performance measure determined, for instance, utilizing the estimating module 216. Advertisements are presented (e.g., displayed) according to the advertisement ranking. Typically, the advertisement having a highest ranking will be awarded the most prominent display position, e.g., the top link of a vertical listing of links on a search engine web page that is displayed as the result of a particular user query. In one embodiment, each instance of an expected advertisement performance is estimated utilizing estimating module 216 and all affected advertisement rankings are adjusted accordingly. The advertisement rankings determined utilizing the ranking module 218 may be stored in a storage device, such as storage device 204. In addition to or rather than ranking module 218 determining advertisement rankings, in one embodiment, ranking module 218 may use the estimated expected advertisement performance measure to inform advertisers what they should change about an advertisement in order to increase its CTR. In one embodiment, ranking module 218 may utilize user gender, age, location, previous searches, and previous advertisement click behavior and/or the request day or time to determine advertisement rankings.

The executing module 220 is configured to implement the advertisement ranking. In some instances, one or more advertisement rankings may not change upon the estimated expected advertisement performance measure. In other instances, each advertisement ranking may change upon an initial or updated estimated expected advertisement performance of one advertisement.

The monitoring module 222 is configured to monitor advertisement performance. Advertisement performance may be monitored to determine when estimated expected advertisement performance measures vary from the subsequent observed/measured advertisement performance. In some embodiments, the monitoring module 222 will notify the search engine provider when the estimated expected advertisement performance varies a specific amount from the subsequent observed advertisement performance, thereby indicating that the advertisement performance prediction model should be updated. In other embodiments, the monitoring module 222 will automatically update the advertisement performance prediction model as needed.

As shown in FIG. 2, the end-user device 206 includes a user input module 234 and a presentation module 236. In some embodiments, one or more of the modules 234 and 236 may be implemented as stand-alone applications. In other embodiments, one or both of the modules 234 and 236 may be integrated directly into the operating system of the end-user device 206. It will be understood by those of ordinary skill in the art that the modules 234 and 236 illustrated in FIG. 2 are exemplary in nature and in number and should not be construed as limiting. Any number of modules may be employed to achieve the desired functionality within the scope of embodiments hereof.

The user input module 206 is configured for receiving input of search query terms. Typically, search query terms are input via a user interface (not shown) associated with the end-user device, or the like. Upon receiving input of search query terms, the presentation module 236 of the end-user device 206 is configured for presenting advertisements in order by a rank number/performance measure. In one embodiment, the presentation module 236 presents a plurality of relevant advertisements utilizing a display device associated with the end-user device 206. Embodiments, however, are not intended to be limited to visual display but rather may also include audio presentation, combined audio/video presentation, and the like.

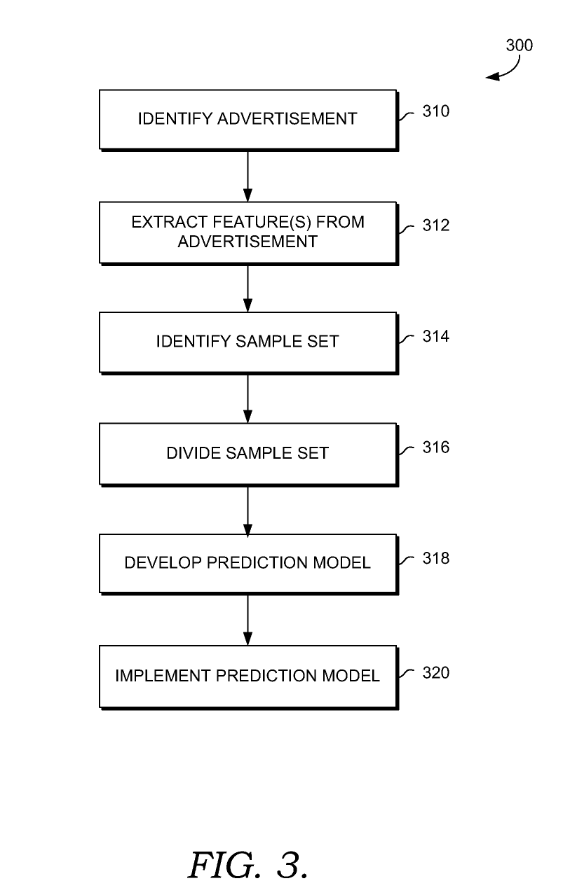

Turning now to FIG. 3, a flow diagram is shown illustrating a method 300 for developing an advertisement performance prediction model, in accordance with an embodiment of the present invention. Initially, as indicated at block 310, an advertisement is identified from previous received advertisements, e.g., advertisements input into the system by an advertiser on a web based user interface. The advertisement may include recognized advertisement information, recognized advertisement performance measures, or a combination thereof. Subsequently, at block 312, one or more advertisement features of the identified advertisement are extracted, e.g., advertisement copy features, advertisement breadth features, advertisement consistency features, advertisement page features, specific advertisement features, CTR advertisement features, performance based features, relevancy features, search data features, and the like. The one or more extracted advertisement features may be stored in a file, database, or like storage device. Alternatively, the advertisement features may be used to develop an advertisement performance prediction model and thereafter discarded.

Next, as indicated at block 314, a sample set is identified. A sample set includes advertisements having at least one recognized information item and/or performance measure associated therewith. The sample set is divided, at block 316, into subsets including, for example, a training set, testing set and validating set, e.g., utilizing dividing component 228 of FIG. 2. As previously mentioned, the sample set may be divided into any number of subsets, and the subsets may have any number of advertisements. Subsequently, as indicated at block 318, the advertisement performance prediction model is developed based on the extracted advertisement features. The prediction model may be developed by any algorithm or machine learning in the form of a logistic regression model, linear regression model, or decision tree. The development process at block 318 may include developing an initial prediction model, testing the prediction model using the testing subset, and enhancing the prediction model if testing provides inaccurate results. The prediction model is then implemented, as indicated at block 320.

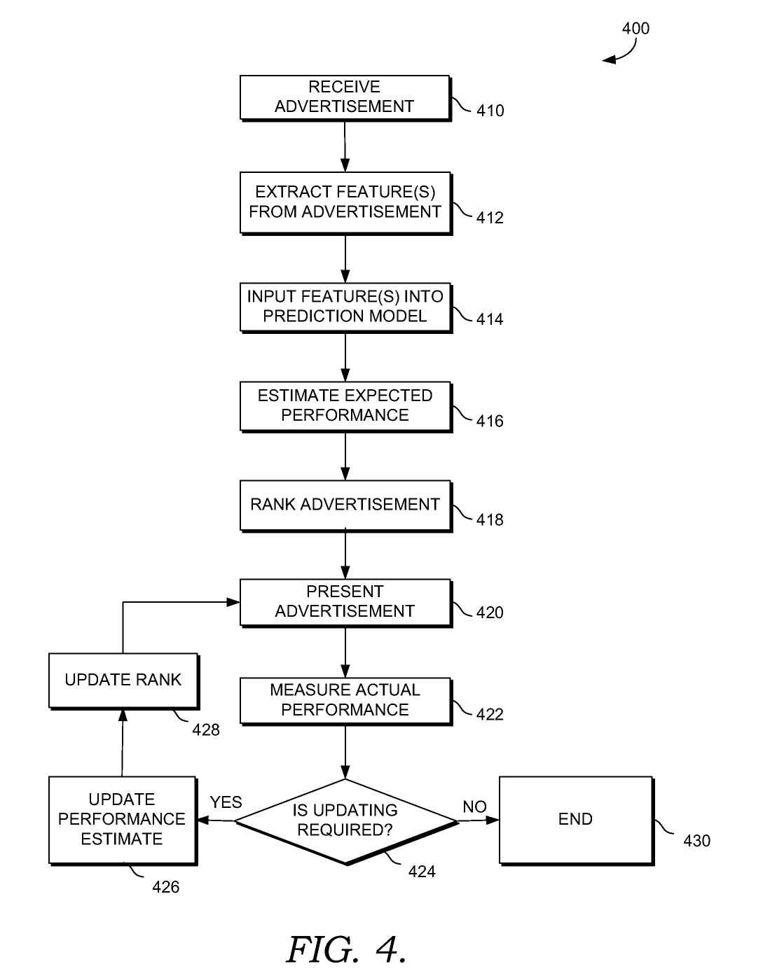

Referring now to FIG. 4, a flow diagram is shown illustrating a method 400 for implementing an advertisement performance prediction model, in accordance with an embodiment of the present invention. Initially, as indicated at block 410, an advertisement is received. The advertisement received at block 410 is an advertisement for which an expected advertisement performance may be estimated. The received advertisement may be an advertisement new to the system, an advertisement displayed a limited number of times, any advertisement in the system, or an advertisement with a low or decreasing estimating confidence. In some embodiments, multiple advertisements may be received at block 410.

At block 412, one or more advertisement features of the received advertisement(s) is extracted. The one or more extracted features are input into the prediction model, as indicated at block 414. The prediction model is used to estimate the advertisement's expected performance, as indicated at block 416. The estimated expected performance may be stored in a database, file, or other storage device.

At block 418, the advertisement is ranked based on the estimated expected advertisement performance determined at block 416. The estimated expected performance determined at block 416 is compared to other advertisements' estimated expected performance in order to determine an advertisement ranking. In one embodiment, a greater estimated expected advertisement performance will result in a greater ranking for a particular advertisement. The advertisement ranking set may be stored in a storage device, such as storage device 204.

At block 420, the advertisement is presented based on the advertisement ranking determined at block 418. In one embodiment, an advertisement having a greater ranking will result in the advertisement being presented in a more prominent display position, such as the top link of a user query.

An advertisement's actual performance is measured at block 422. At block 424, it is determined whether updating the performance estimate is required. In one embodiment, determining whether to update the performance estimate may be based on a comparison of the estimated expected advertisement performance to subsequent actual advertisement performance. The determination at block 424 of whether the performance estimate should be updated may be based on a specific variation of the actual advertisement performance from the estimated expected advertisement performance. If it is determined at block 424 that the performance estimate need not be updated, the process ends at block 430. On the other hand, if it is determined at block 424 that the performance estimate should be updated, the performance estimate is updated at block 426. Upon updating the performance estimate, the advertisement ranking is updated at block 428 based on the updated performance estimate. The advertisement is presented, at block 420, based on the updated ranking.

As described herein above, embodiments of the present invention provide systems, methods, and computer-readable media for developing an advertisement performance prediction model and utilizing the prediction model to estimate expected performance of advertisements. The advertisement performance prediction model is developed using advertisement features extracted from a sample set. In embodiments, the advertisement performance prediction model may be a logistic regression model, a decision tree, or any other prediction model known to those of ordinary skill in the art. To estimate expected advertisement performance, advertisement features are extracted from an advertisement that was not included in the sample set. The extracted advertisement feature(s) is then input into the advertisement performance prediction model and expected advertisement performance is estimated. The estimated expected advertisement performance may then be used to appropriately rank the advertisement with respect to a plurality of other advertisements. In embodiments, the advertisement may be displayed in accordance with the advertisement ranking, thereby improving search engine provider and advertiser revenues, as well as user satisfaction.

Embodiments described herein are intended in all respects to be illustrative rather than restrictive. Alternative embodiments will become apparent to those of ordinary skill in the art without departing from the scope of embodiments described herein.

From the foregoing, it will be seen that embodiments of the present invention are well adapted to attain ends and objects set forth above, together with other advantages which are obvious and inherent to the systems and methods described. It will be understood that certain features and sub-combinations are of utility and may be employed without reference to other features and sub-combinations. This is contemplated by and is within the scope of the claims.

What is claimed is:

1. A computerized system for developing an advertisement performance prediction model configured to estimate expected performance of advertisements, the system comprising:
an extracting component configured to extract at least one feature from a plurality of advertisements, one or more of the plurality of advertisements having at least one historical measure of performance; and
a developing component configured to develop the advertisement performance prediction model utilizing the extracted at least one feature and the at least one historical measure of performance for each of the plurality of advertisements.

2. The computerized system of claim 1, further comprising an implementing component configured to implement the advertisement performance prediction model to estimate expected performance of advertisements.

3. The computerized system of claim 1, further comprising a sample set identifying component configured for identifying the plurality of advertisements and creating a sample set of advertisements including at least a portion of the plurality of advertisements.

4. The computerized system of claim 1, wherein the at least one feature comprises one or more of a user gender, a user age, a user location, a user interest, a user previous search, a user previous advertisement click behavior, a request day, a request time, or a combination thereof.

5. The computerized system of claim 1, wherein the at least one feature comprises at least one datum, at least one value, or a combination thereof that represents at least one of an advertising information item or the at least one historical measure of performance.

6. The computerized system of claim 1, wherein the at least one feature comprises one or more of an advertisement copy feature, an advertisement breadth feature, an advertisement consistency feature, an advertisement page feature, a specific advertisement feature, a click-through rate advertisement feature, a performance-based feature, a query-based feature, and a search data feature.

7. The computerized system of claim 1, wherein the advertisement performance prediction model comprises a logistic regression model, a decision tree, a regression tree, a neural network, a boosted tree, or a support vector machine.

8. The computerized system of claim 1, wherein the advertisement performance prediction model is developed via machine learning, an algorithm, or a combination thereof.

9. A method for estimating expected performance of advertisements, the method comprising:
receiving an advertisement;
extracting at least one feature from the received advertisement;
inputting the at least one extracted feature into an advertisement performance prediction model, wherein the advertisement performance prediction model is based upon extracted features, recognized information items and/or historical performance of a plurality of advertisements; and
utilizing the advertisement performance prediction model to estimate expected performance of the received advertisement.

10. The method of claim 9, further comprising ranking the received advertisement relative to at least a portion of the plurality of advertisements utilizing the estimated expected performance of the received advertisement.

11. The method of claim 9, further comprising:
measuring the actual performance of the received advertisement; and
updating the estimated expected performance of the received advertisement in accordance with the measured actual performance thereof.

12. The method of claim 9, further comprising developing the advertisement performance prediction model.

13. The method of claim 12, wherein developing the advertisement prediction model comprises:
identifying the plurality of advertisements,
extracting at least one feature from each of the plurality of advertisements; and
developing the advertisement prediction model utilizing the extracted at least one feature and at least one of a recognized information item and/or a historical performance measure associated with each of the plurality of advertisements.

14. The method of claim 9, wherein each of the extracted features comprises one or more of an advertisement copy feature, an advertisement breadth feature, an advertisement consistency feature, an advertisement page feature, a specific advertisement feature, a click-through rate advertisement feature, a performance-based feature, a query-based feature, and a search data feature.

15. The method of claim 9, wherein the estimated expected performance of the received advertisement comprises a probability a user will perform an action with respect to the received advertisement.

16. The method of claim 15, wherein the probability a user will perform an action with respect to the received advertisement comprises a click-through rate.

17. One or more computer-readable media having computer-executable instructions embodied thereon that, when executed, perform a method for estimating expected performance of advertisements, the method comprising:
identifying at least one advertisement having one or more recognized information items and/or performance measures associated therewith;
extracting one or more features from the at least one advertisement;
developing an advertisement performance prediction model based upon the one or more extracted features and at least one of the one or more recognized information items and/or performance measures;
extracting at least one feature from a first advertisement that is different than the at least one advertisement; and
estimating the expected performance of the first advertisement utilizing the advertisement performance prediction model.

18. The one or more computer-readable media of claim 17, wherein the method further comprises ranking the first advertisement relative to a plurality of other advertisements utilizing the estimated expected advertisement performance measure.

19. The one or more computer-readable media of claim 17, wherein the method further comprises:
measuring the actual performance of the first advertisement; and
updating the estimated expected performance of the first advertisement in accordance with the measured actual performance thereof.

20. The one or more computer-readable media of claim 17, wherein each of the one or more features comprises an advertisement copy feature, an advertisement breadth feature, an advertisement consistency feature, an advertisement page feature, a specific advertisement feature, a click-through rate advertisement feature, a performance-based feature, a query-based feature, a search data feature, or a combination thereof.
